(19) United States
(12) Patent Application Publication
(10) Pub. No.: US 2016/0057819 A1
(43) Pub. Date: Feb. 25, 2016

(54) Smart LED Lighting System

(71) Applicant: CLEDOS green tech Limited, Hong Kong (HK)

(72) Inventors: James Wang, Hong Kong (HK); Kei May Lau, Hong Kong (HK); Parco Wong, Hong Kong (HK); Terence Cho, Hong Kong (HK); Zhaojun Liu, Hong Kong (HK); Eddie Chong, Hong Kong (HK)

(21) Appl. No.: 14/468,153

(22) Filed: Aug. 25, 2014

(51) Int. Cl. H05B 33/08; H05B 37/02

(52) U.S. Cl. CPC H05B 33/086; H05B 37/0263; H05B 37/0272; H05B 33/0869

(57) ABSTRACT

A light emitting diode (“LED”) lighting system comprises an LED lighting fixture having LEDs, a network interface cable, and one or more controllers. The network interface cable has multiple pairs of wires. A certain one of the one or more LED controllers is connected to the LED lighting fixture via the network interface cable. The certain one of the one or more LED controllers powers the LED lighting fixture via the network interface cable.

### FIELD OF INVENTION

The disclosure relates to methods, systems, and apparatuses for light emitting diode lighting, and, more particularly, to methods, systems, and apparatuses for smart light emitting diode lighting.

### BACKGROUND

Smart device management is a thriving topic of research. The reason for such research is that every home has numerous devices that may need management including electrical systems (e.g., light switches, televisions, radios, etc.), mechanical systems (e.g., windows, doors, door locks, etc.), communication systems (e.g., a security system, a local area network (“LAN”), etc.), and entertainment systems (e.g., televisions, home theater systems, etc.). A smart home (or connected home) is a form of device management that aims to have a central automated control over these numerous devices. By wiring controls of each home device to one point, commonly known as a control system, the home devices can be integrated and made interoperable. For example, a same device used to control a home's interior lighting can also be used to adjust heat in a living room, turn off a stereo, turn on a television, etc.

However, with respect to lighting applications, such wiring may not be entirely feasible in part due to the vast number of light switches in any given residential and/or commercial area. Thus, current smart technologies are not viable in lighting applications. Furthermore, interoperability problems of different hardware and software components (e.g., of home devices), limited service scalability, complexity of configuration, and excessive cost have prevented mass adoption of current smart technologies with respect to lighting systems.

In addition to smart technologies, the use of light emitting diodes (“LEDs”) has slowly taken over as the next innovation in lighting. LEDs are semiconductor light sources, which have longer lifetimes, faster switching properties, smaller physical sizes, greater durability and higher energy efficiencies than current day lighting devices, e.g., fluorescent lights bulbs or incandescent light bulbs. LEDs are solid state devices, and if operated at low currents and at low temperatures, are subject to limited device wear and tear. Lifetimes of LEDs are anywhere from around five to fifty times longer than fluorescent light bulbs and incandescent light bulbs. LEDs are also less susceptible to damage than fluorescent and incandescent light bulbs.

LEDs also produce more light per watt than incandescent bulbs, and are ideal for use in applications that are subject to frequent on-off cycling, unlike fluorescent lamps that burn out more quickly when cycled frequently. LEDs can very easily be dimmed continuously unlike fluorescent lamps which require a certain threshold voltage to maintain illumination.

Even more so, LEDs have been found to have significant environmental benefits compared to other types of lights. For instance, a building's carbon footprint from lighting can be significantly reduced by exchanging all incandescent bulbs for LED light bulbs. LEDs are also non-toxic compared to fluorescent light bulbs, which contain traces of mercury.

With the advantages of LEDs, it is desirable to develop new methods, systems, and apparatuses for a smart LED system to deploy and operate LEDs.

### SUMMARY OF INVENTION

Briefly, the disclosure relates to a light emitting diode (“LED”) lighting system, comprising: an LED lighting fixture having LEDs; a network interface cable, wherein the network interface cable having multiple pairs of wires; and one or more controllers, wherein a certain one of the one or more LED controllers is connected to the LED lighting fixture via the network interface cable, and wherein the certain one of the one or more LED controllers powers the LED lighting fixture via the network interface cable.

### DESCRIPTION OF THE DRAWINGS

The foregoing and other aspects of the disclosure can be better understood from the following detailed description of the embodiments when taken in conjunction with the accompanying drawings.

FIG. 1 illustrates a diagram of a smart LED lighting system, where a light emitting diode (“LED”) controller drives an LED lighting fixture.

FIG. 2 illustrates a block diagram of an LED controller.

FIG. 3 illustrates a diagram of a network interface cable powering an LED lighting fixture.

FIG. 4 illustrates another diagram of a network interface cable powering an LED lighting fixture.

FIG. 5 illustrates a diagram of a smart LED lighting system, where an LED controller drives multiple LED lighting fixtures.

FIG. 6 illustrates a diagram of a smart LED lighting system having a wireless router connected to multiple LED controllers.

FIG. 7 illustrates a diagram of a smart LED lighting system, where a mobile device controls lighting devices at a house.

FIG. 8 illustrates a diagram of a user interface on a mobile device to control lighting conditions.

FIG. 9 illustrates a diagram of a smart LED lighting system for wirelessly controlling street lamps.

### DETAILED DESCRIPTION OF THE EMBODIMENTS

In the following detailed description of the embodiments, reference is made to the accompanying drawings, which form a part hereof, and in which is shown by way of illustration of specific embodiments in which the disclosure may be practiced.

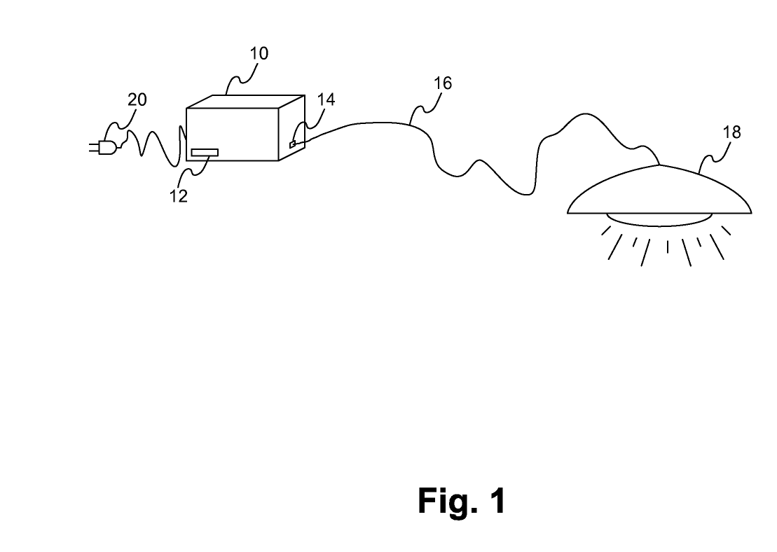

FIG. 1 illustrates a diagram of a smart LED lighting system, where a light emitting diode (“LED”) controller drives an LED lighting fixture. A smart LED lighting system comprises an LED controller 10, a network interface cable 16, and a lighting fixture 18. The LED controller 10 comprises a plug 20, a pairing initialization button 12, and at least one network interface connector 14. The plug 20 of the LED controller 10 can be plugged into a wall socket (e.g., a home power socket) for receiving an alternating current (“AC”) input voltage. The LED controller 10 provides electrical power via the network interface cable 14 to drive the LED lighting fixture 18.

The network interface cable 16 has one end plugged in to the network interface connector 14 of the LED controller 10 and another end plugged in to the LED lighting fixture 18. The network interface cable 16 can comprise multiple pairs of wires. Each pair of wires of the network interface cable 16 can be used to power one or more LEDs of the lighting fixture 18. It is understood by a person having ordinary skill in the art that a network interface cable can be a category 5 cable, RJ11 cable, RJ21 cable, RJ45 cable, RJ48 cable, RJ61 cable, or other electrical cable.

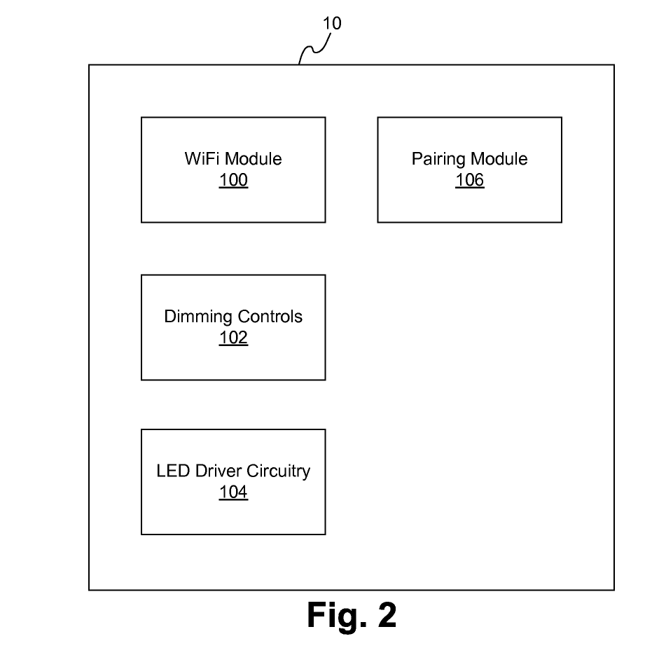

FIG. 2 illustrates a block diagram of an LED controller. The LED controller 10 comprises a WiFi module 100, dimming controls 102, LED driver circuitry 104, and a paring module 106. The LED controller 10 may also have other control logic for performing various functions, including various sensors and diagnostic circuitry. Based on the present disclosure, a person having ordinary skill in the art can appreciate that other electronic circuitry can be included in the LED controller as desired to provide for additional functions for the controller 10 to perform.

The WiFi module allows the LED controller 10 to communicate to a wireless router (not shown). The wireless router can route commands to and from the LED controller 10. For instance, a mobile device (not shown) can access the LED controller 10 from a remote location to control the LED lighting fixture 18 by sending commands to the LED controller 10 via the router.

The dimming control 102 allows the LED controller 10 to control the brightness of the LED lighting fixture 18 via the network interface cable 16. For example, the dimming control 102 can adjust the current to the LEDs of the LED lighting fixture 18 to adjust the brightness of the LED lighting fixture 18.

The LED driver 104 has electrical components to receive the AC input voltage and drive the LEDs of the LED lighting fixture 18. For instance, the LED controller 10 may have well known circuitry to those persons having ordinary skill in the art, including a boost circuit, a rectifier, regulator, and/or other circuitry for transforming AC input voltage to power the LEDs of the LED lighting fixture 18. A person having ordinary skill in the art is aware of such circuitry. Thus, the present disclosure can also include such electrical circuitry to drive the LED lighting fixture.

The pairing module 106 can be used to pair the LED controller 10 to a local router. Once the pairing module 106 is activated the LED controller 10 can search for routers to pair to. Once paired using a wireless communications standards, e.g., Bluetooth, WiFi, or other communications standard, the paired router can assign a network address to the LED controller 10. Furthermore, the router can route commands from a user, e.g., via the internet if the router is internet enabled, to the LED controller 10.

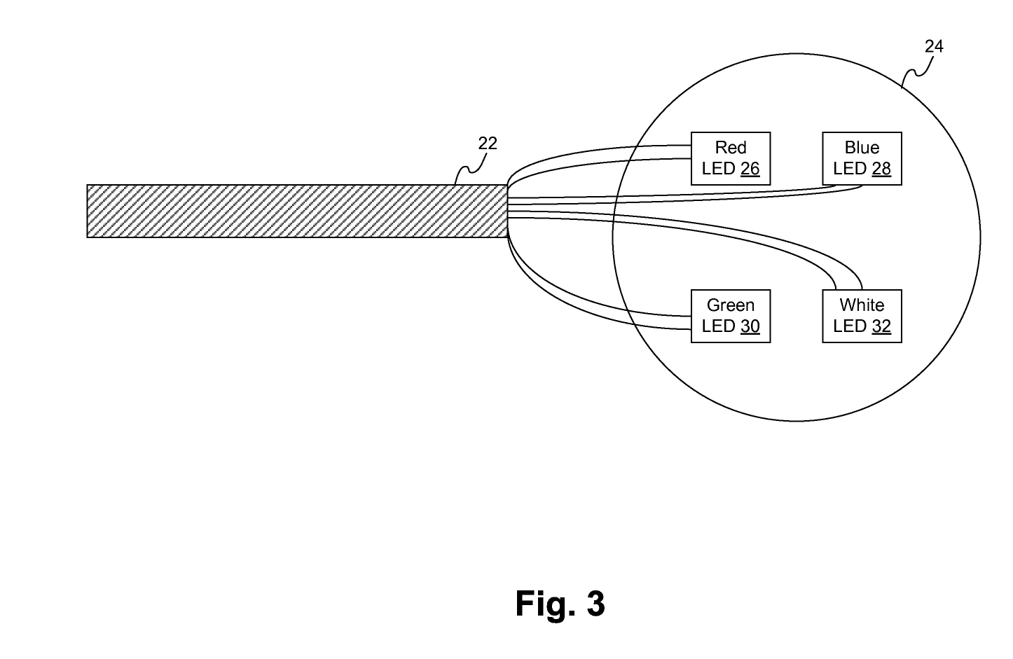

FIG. 3 illustrates a diagram of a network interface cable powering an LED lighting fixture. A network interface cable 22, connected to an LED controller, can drive a number of LEDs 26-32 of a lighting fixture 24. For instance, if the network interface cable 22 has four pairs of wires, a first pair can be used to drive a red LED 26, a second pair can be used to drive a blue LED 28, a third pair can be used to drive a green LED 30, and a fourth pair can be used to drive a white LED 32. By having four distinctly colored LEDs in the same lighting fixture 24, the brightness level of each of the LEDs 26-32 can be individually set to provide for a spectrum of colors. In addition, the lighting fixture 24 can also be set such that a predefined color is shown from the lighting fixture 24 by adjusting the various brightness levels of the LEDs 26-32 to obtain the predefined color. A person having ordinary skill in the art can appreciate that there are numerous methods and defined brightness levels of different colored LEDs to reach a specific overall color performance. For instance, an LED television also uses such methods to reach a predefined color for a specific pixel (or area) of the LED television. Similarly to the LED television, the light fixture 24 can adjust that predefined color to a different color at any time. The number of LEDs on the lighting fixture 24 can be adjusted as needed.

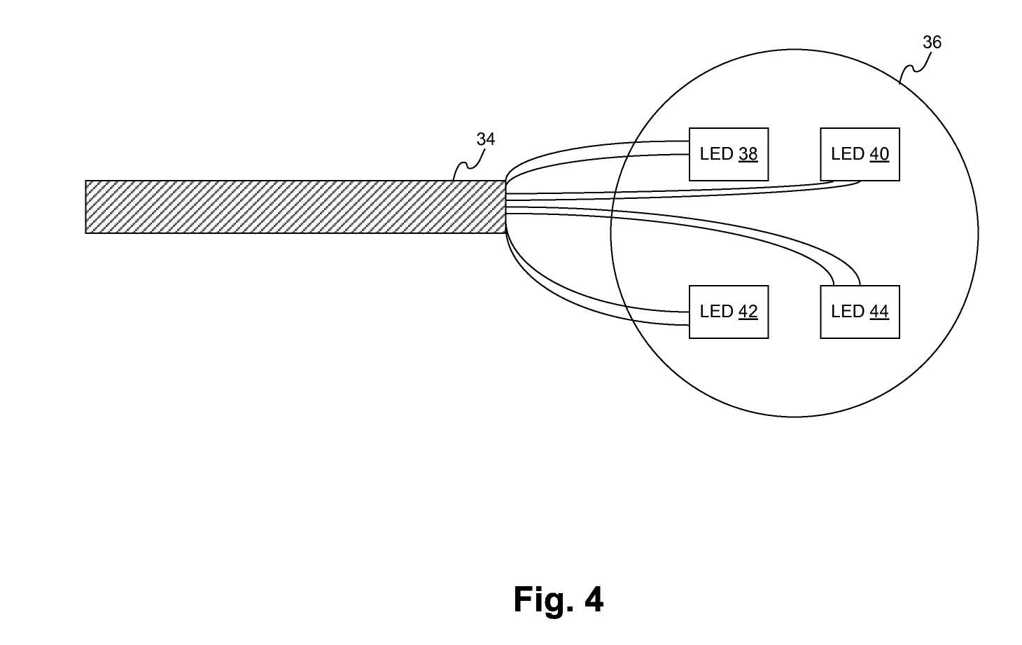

FIG. 4 illustrates another diagram of a network interface cable powering an LED lighting fixture. A network interface cable 34, connected to an LED controller, can drive a number of LEDs 38-44. Each wired pair of the network interface cable 34 can independently drive one of the LEDs 38-44. The respective LED controller can dim the LEDs 38-44 by varying the current through wired pairs of the network interface cable 34. Since each of the LEDs 38-44 can be independently operated, there can be numerous brightness levels that are achievable by the respective lighting fixture.

In other embodiments, each wired pair of the network interface cable can be used to drive multiple LEDs in parallel and/or in series. A predefined number of LEDs can be driven by the network interface cable according to the present disclosure. For instance, if the network interface cable has eight wired pairs, then at least eight different LEDs can be driven by such cable. Since each of the wired pairs can drive one or more LEDs, the number of LEDs driven by a single wired pair can vary as needed or desired.

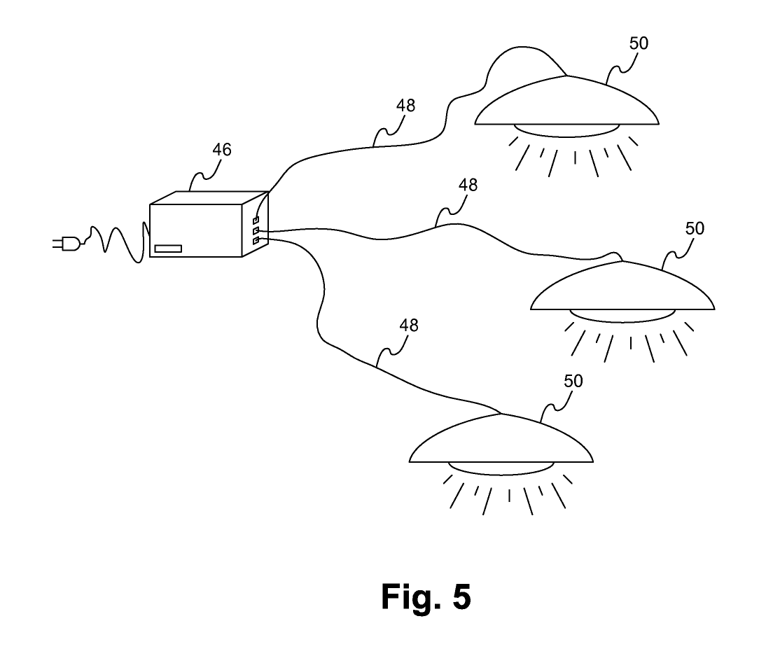

FIG. 5 illustrates a diagram of a smart LED lighting system, where an LED controller drives multiple LED lighting fixtures. A smart LED lighting system can comprise an LED controller 46, network interface cables 48, and lighting fixtures 50. The LED controller 46 can be connected to the multiple lighting fixtures 50 via the network interface cables 48. The network interface cables 48 drive electrical current to the LEDs of the lighting fixtures 50. The lighting fixtures 50 can be located in adjacent areas or in different areas altogether. For instance, the lighting fixtures 50 can be positioned in a kitchen of a home. Alternatively, one of the lighting fixtures can be located in the kitchen of a home, another one in the living room of the home, and yet another one in the bedroom of the home. It is understood that the LED controller 46 can be connected to a various number of LED lighting fixtures. To aid in the understanding of the invention, the three lighting fixtures 50 are used for illustration purposes, and is not meant to limit the present disclosure.

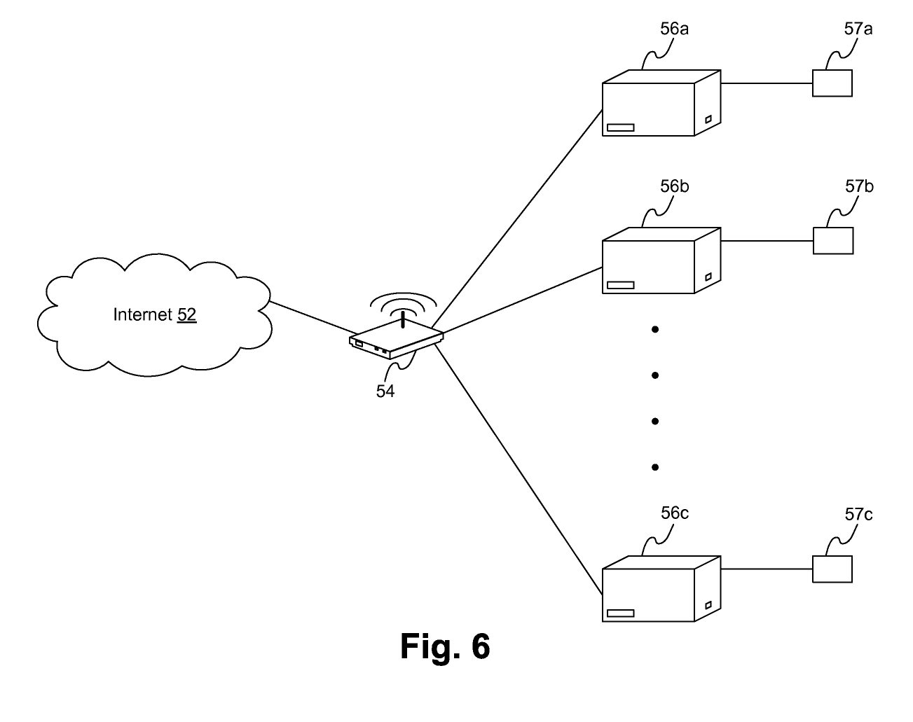

FIG. 6 illustrates a diagram of a smart LED lighting system having a wireless router connected to multiple LED controllers. A smart LED lighting system can comprise multiple LED controllers 56a-56c, which can be connected to the internet 52 via a wireless router 54. The LED controllers 56a-56c can each control a certain number of LED lighting fixtures at each of their respective locations. For instance, one of the LED controllers 56a can be located at a kitchen of a home; another one of the LED controllers 56b can be located at a garage of the home; yet another one of the LED controllers 56c can be located at a living room of the home; and so on and so forth. The LED controllers 56a-56c can also be located at different homes or geographical locations as well.

The smart LED lighting system can further comprise light sensors 57a-57c that are connected to each of the controllers 56a-56c. The light sensors 57a-57c can detect the lighting level at each of the respective locations of the home, and adjust the lighting levels for the home via the controllers 56a-56c according to preset or default preferences.

In an embodiment, the lighting level for each location of the home can be substantially the same via the smart LED lighting system. For instance, if the living room of the home is illuminated by sunlight, the light sensor 57c can detect that lighting level and route that lighting level through the smart LED lighting system to set the lighting levels of other locations of the home. The LED lighting system can then control the controllers 56a and 56b of the other locations of the home to keep the light at a predefined brightness and/or intensity. The lighting level of the garage can be set to match the living room lighting level, where the living room may be illuminated by sunlight. Thus, a resident/user of the home can travel from one area (e.g., the living room of the home) to another area (e.g., the garage of the home) without having to readjust their vision for each location since the lighting levels of each location would be substantially similar.

If the LED controllers 56a-56c are connected to the router 54 and the router 54 is connected to the internet 52 (or a local area network), a user can control the operation of the LED controllers 56a-56c via the internet 52 (or via the local area network). In this manner, the user can remotely control any LED lighting fixtures that are connected to the LED controllers 56a-56c.

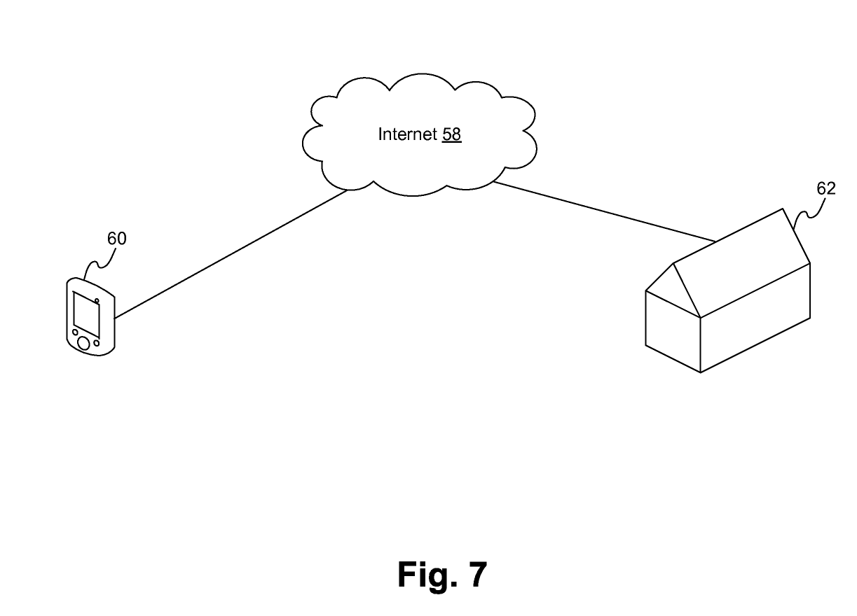

FIG. 7 illustrates a diagram of a smart LED lighting system, where a mobile device controls lighting devices at a house. In an example, a mobile device 60, e.g., a cellular phone, a tablet, a laptop, or other mobile device, can control the LED lighting fixtures of a home 62 via the internet 58. The home 62 can have one or more LED controllers (not shown) to control the LED lighting fixtures of the home 62. The home 62 can also have a router to route commands to and from the LED controllers.

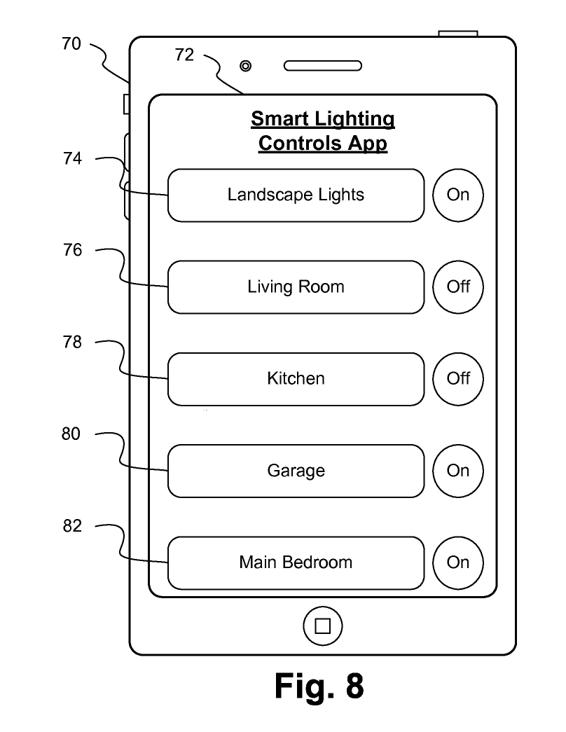

FIG. 8 illustrates a diagram of a user interface on a mobile device to control lighting conditions. A mobile device 70 can have a touchscreen 72 and software for controlling the LED controller of the smart LED lighting system. The software can be downloaded to the mobile device 70 as a software application. The application can have a user interface displayed on the screen 72. The user interface can have the various areas controlled by the LED controller displayed. A first area 74 of the user interface can be labeled “landscape lights”. A second area 76 of the user interface can be labeled “living room”. A third area 78 of the user interface can be labeled “kitchen”. A fourth area 80 of the user interface can be labeled “garage”. A fifth area 82 of the user interface can be labeled “main bedroom”. Additional areas can be added or subtracted. In addition, the labels can also be changed by the user depending on how the user decides to define a location. A user can touch the areas 74-82 to toggle between activating and deactivating the respective LED lights associated to that toggled area. For instance, if the user touches the area 74, the landscape lights, which are designated as on, can be turned off

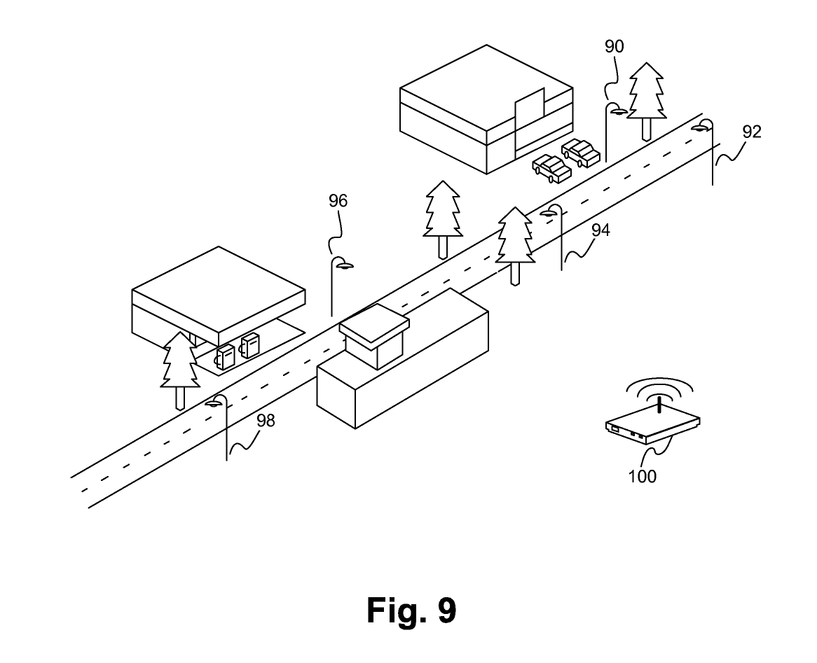

FIG. 9 illustrates a diagram of a smart LED lighting system for wirelessly controlling street lamps. The smart LED lighting system can also be used for other lighting applications. For instance, street lamps 90-98 can be controlled using a wireless router 100. The router 100 can be further connected to a local area network or the internet for a user to access and control the operation of the street lamps 90-98. Each of the street lamps 90-98 can have an LED controller that is wirelessly connected to the router 100. The LED controllers of the street lamps 90-98 can have additional electronic modules for detectors. For instance, a motion detector can be connected to the LED controller such that when motion is detected the street lamps 90-98 can have a brightness level at eighty percent of the maximum brightness of the street lamps. When motion is no longer detected, the brightness level of the street lamps 90-98 can be brought down to fifty percent of the maximum light brightness of the street lamps.

While the disclosure has been described with reference to certain embodiments, it is to be understood that the disclosure is not limited to such embodiments. Rather, the disclosure should be understood and construed in its broadest meaning, as reflected by the following claims. Thus, these claims are to be understood as incorporating not only the apparatuses, methods, and systems described herein, but all those other and further alterations and modifications as would be apparent to those of ordinary skilled in the art.

1. A light emitting diode (“LED”) lighting system, comprising:
an LED lighting fixture having LEDs;
a network interface cable, wherein the network interface cable having multiple pairs of wires;
one or more LED controllers; and
a wireless router,
wherein the wireless router is connected to the certain one of the LED controllers to route remote commands to the LED lighting fixture,
wherein a certain one of the LED controllers is connected to the LED lighting fixture via the network interface cable, and
wherein the certain one of the LED controllers powers the LED lighting fixture via the network interface cable.

2. The LED lighting system of claim 1 wherein the LEDs comprise a red LED, a green LED, a blue LED, and a white LED, wherein the network interface cable has at least four pairs of wires, wherein a first pair of the wires drives the red LED, a second pair of the wires drives the green LED, a third pair of the wires drives the blue LED, and a fourth pair of the wires drives the white LED.

3. The LED lighting system of claim 2 further comprising a light sensor, wherein the light sensor senses an emitted color of the light fixture, and wherein the LED controller adjusts brightness levels of each of the LEDs as a function of the emitted color.

4. The LED lighting system of claim 1 further comprising light sensors, wherein the controllers are located at a plurality of locations, wherein the light sensors detect the lighting levels of the plurality of locations, and wherein the lighting levels of the plurality of locations are adjusted to a predefined lighting level via the controllers.

5. (canceled)

6. The LED lighting system of claim 1 wherein the certain one of the LED controllers comprises a wireless communications module to connect to the wireless router, wherein the wireless router has internet access, and wherein a user commands are routed to the certain one of the LED controllers via the wireless router.

7. The LED lighting system of claim 1 further comprising a cloud interface, wherein the cloud interface is connected to the wireless router via the internet access, wherein the cloud interface is operable on a mobile computing device, and wherein the cloud interface provides wireless control of the lighting fixture.

8. The LED lighting system of claim 1 wherein the wireless router and the certain one of the LED controllers are paired using a pairing protocol to engage in wireless communications, and wherein the wireless router assigns a network address to the certain one of the LED controllers.

9. The LED lighting system of claim 1 wherein the wireless router, the certain one of the LED controllers, and the LED lighting fixture are at remote locations.

10. The LED lighting system of claim 1 further comprising one or more other LED lighting fixtures and one or more other network interface cables, wherein the LED controllers are connected to the one or more other LED lighting fixtures via the one or more other network interface cables.

11. The LED lighting system of claim 10 wherein the one or more other LED lighting fixtures are powered by the one or more other network interface cables.

12. A light emitting diode (“LED”) lighting system, comprising:
an LED lighting fixture having LEDs;
a network interface cable, wherein the network interface cable having four multiple pairs of wires;
one or more LED controllers; and
a wireless router,
wherein a certain one of the LED controllers is connected to the LED lighting fixture via the network interface cable,
wherein a certain one of the LED controllers powers the LED lighting fixture via the network interface cable,
wherein the wireless router is connected to the certain one of the LED controllers to route remote commands to the LED lighting fixture,
wherein the LEDs comprise a red LED, a green LED, a blue LED, and a white LED,
wherein a first pair of the network interface cable drives the red LED, a second pair of the network interface cable drives the green LED, a third pair of the network interface cable drives the blue LED, and a fourth pair of the network interface cable drives the white LED,
wherein the certain one of the LED controllers comprises a wireless communications module to connect to the wireless router,
wherein the wireless router has internet access, and
wherein a user commands are routed to the certain one of the LED controllers via the wireless router.

13. The LED lighting system of claim 12 further comprising a light sensor, wherein the light sensor senses an emitted color of the light fixture, and wherein the certain one of the LED controllers adjusts brightness levels of each of the LEDs as a function of the emitted color.

14. The LED lighting system of claim 12 further comprising a cloud interface, wherein the cloud interface is connected to the wireless router via the internet access, wherein the cloud interface is operable on a mobile computing device, and wherein the cloud interface provides wireless control of the lighting fixture.

15. The LED lighting system of claim 12 wherein the wireless router and the certain one of the LED controllers are paired using a pairing protocol to engage in wireless communications, and wherein the wireless router assigns a network address to the certain one of the LED controllers.

16. The LED lighting system of claim 12 wherein the wireless router, the certain one of the LED controllers, and the LED lighting fixture are at remote locations.

17. The LED lighting system of claim 12 further comprising one or more other LED lighting fixtures and one or more other network interface cables, wherein the certain one of the LED controllers is connected to the one or more other LED lighting fixtures via the one or more other network interface cables, and wherein the one or more other LED lighting fixtures are powered by the one or more other network interface cables.

18. The LED lighting system of claim 12 further comprising light sensors, wherein the LED controllers are located at a plurality of locations, wherein the light sensors detect the lighting levels of the plurality of locations, and wherein the lighting levels of the plurality of locations are adjusted to a predefined lighting level via the LED controllers.

19. A light emitting diode (“LED”) lighting system, comprising:
an LED lighting fixture having LEDs;
a network interface cable, wherein the network interface cable having four multiple pairs of wires;
a wireless router;
one or more LED controllers each having a wireless communications module to connect to the wireless router;
light sensors; and
a cloud interface,
wherein a certain one of the LED controllers is connected to the LED lighting fixture via the network interface cable,
wherein the certain one of the LED controllers powers the LED lighting fixture via the network interface cable,
wherein the wireless router is connected to the certain one of the LED controllers to route remote commands to the LED lighting fixture,
wherein the LEDs comprise a red LED, a green LED, a blue LED, and a white LED,
wherein a first pair of the network interface cable drives the red LED, a second pair of the network interface cable drives the green LED, a third pair of the network interface cable drives the blue LED, and a fourth pair of the network interface cable drives the white LED,
wherein a certain one of the light sensors senses an emitted color of the light fixture,
wherein the certain one of the LED controllers adjusts brightness levels of each of the LEDs as a function of the emitted color,
wherein the wireless router has internet access,
wherein a user commands are routed to the certain one of the LED controllers via the wireless router,
wherein the cloud interface is connected to the wireless router via the internet access,
wherein the cloud interface is operable on a mobile computing device,
wherein the cloud interface provides wireless control of the lighting fixture,
wherein the wireless router and the certain one of the LED controllers are paired using a pairing protocol to engage in wireless communications, and
wherein the wireless router assigns a network address to the LED controllers.

20. The LED lighting system of claim 19 wherein the LED controllers are located at a plurality of locations, wherein the other ones of the light sensors detect the lighting levels of the plurality of locations, and wherein the lighting levels of the plurality of locations are adjusted to a predefined lighting level via the LED controllers.
